(19) United States
(12) Patent Application Publication
(10) Pub. No.: US 2008/0136911 A1
(43) Pub. Date: Jun. 12, 2008

(54) DISPLAY SYSTEM FOR A VEHICLE

(75) Inventors: Aric Shaffer, Ypsilanti, MI (US); Ronald Miller, Saline, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/608,273

(22) Filed: Dec. 8, 2006

(51) Int. Cl. H04N 7/18

(52) U.S. Cl. 348/148; 348/E07.085

(57) ABSTRACT

The embodiments described herein include a display system and method for a vehicle. The vehicle includes an interior with a front portion and a camera that is configured to capture images of an area in a vicinity of the vehicle. A display unit is configured to communicate with the camera while having a first view side for displaying images captured by the camera. In one embodiment, the first viewing side faces the front portion of the interior.

### TECHNICAL FIELD

The embodiments described herein relate to a display system for a vehicle.

### BACKGROUND

Reverse park aid systems are commonly installed on vehicles to aid the driver when driving in reverse. Such systems typically include a camera configured to capture video of an area behind the vehicle. This video is fed to a display conventionally located in the center console of the vehicle. The display is located at a less than optimal location within the instrument panel. Particularly, the vehicle operator may have to look downward at the display towards a lower part of the instrument panel when operating the vehicle in reverse. Additionally, utilizing the display within the instrument panel for the reverse park aid system interrupts the use of the display by other vehicle systems such as the audio system, navigation system, and the like.

The embodiments described herein were conceived in view of these and other disadvantages of conventional reverse park aid systems that utilize a display located within a vehicle's instrument panel.

### SUMMARY

The embodiments described herein include a display system and method for a vehicle. The vehicle includes an interior with a front portion. A camera is configured to capture images of an area in a vicinity of the vehicle. A display unit is configured to communicate with the camera while having a first viewing side for displaying images captured by the camera. In one embodiment, the first viewing side faces the front portion of the interior.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a vehicle having a display system in accordance with an embodiment of the present invention;

FIG. 2 illustrates a block diagram of the display system of FIG. 1; and

FIG. 3 is a flow chart of a method for displaying images through the use of the display system of FIGS. 1 and 2.

### DETAILED DESCRIPTION OF THE PREFERRED EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

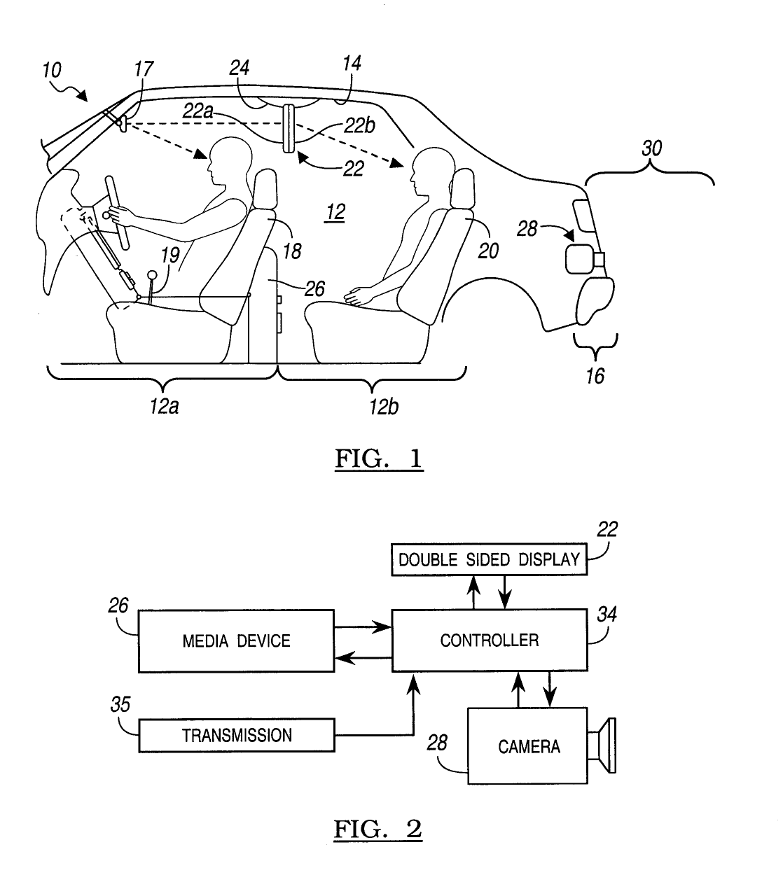

Referring to FIG. 1, a vehicle 10 is shown having a display system in accordance with an embodiment of the present invention. Vehicle 10 includes an interior 12, a roof 14 and a rear portion 16. Interior 12 may be divided into a front portion 12a and a back portion 12b. Within front portion 12a, a front seat 18 is provided for a vehicle driver and/or occupant. Additionally, a back seat 20 is located within back portion 12b. A gear shift 19 that is operable with a transmission (not shown) enables the vehicle operator to select various gears (i.e., drive, reverse, and the like) that allow vehicle 10 to move in a desired direction. A rearview mirror 17 is installed within front portion 12a for enabling a vehicle operator to view areas within back portion 12b including a display 22.

Display 22 includes a base 24 that is mounted to roof 14. Display 22 also includes a first viewing side 22a and a second viewing side 22b. First viewing side 22a faces front portion 12a while viewing side 22b faces back portion 12b of interior 12. Accordingly, occupants in either front seat 18 or a back seat 20 may view images displayed by display 22. Particularly, a vehicle operator seated in front seat 18 may view images displayed on first viewing side 22a. Occupants seated in back seat 20 may view images displayed on second viewing side 22b. Thus, display 22 may be a double-sided liquid crystal display (LCD) or an organic light emitting diode(OLED). Display 22 is capable of displaying multiple images provided by multiple data inputs. For example, first viewing side 22a is configured to receive and display one data input while second viewing side 22b may receive and display a second data input that is independent of the first data input. It is recognized that exemplary double-sided OLEDs are available from AU Optronics Corporation of America, 9720 Cypruswood Drive, Suite 241, Houston, Tex. 77070. Additionally, double-sided LCDs are available from Tianma Microelectronics USA Inc., 21138 Commerce Pointe Dr., Walnut, Calif. 91789. It is recognized, however, that display 22 may be virtually any type of display configured to have a first and a second viewing side configured to display at least two independent images.

A media device 26 is operable with display 22 and provides a data input having data that is displayable by second viewing side 22b. In one embodiment, media device 26 is a vehicle entertainment system adapted to receive removable media such as DVDs, CDs, and the like.

Within rear portion 16 a camera 28 is installed. In one embodiment, camera 28 is a digital camera adapted to capture still images or video in a digital format. In one embodiment, camera 28 is adapted to capture images within an area 20 so as to aid a vehicle operator when driving in reverse. Camera 28 begins capturing images upon the receipt of a signal from the transmission that the reverse gear has been selected. Accordingly, images of area 30 are communicated to display 22 and displayed on viewing side 22a. The images displayed on the viewing side 22a are then viewable by the vehicle operator through the use of rearview mirror 17. Alternatively, the vehicle operator may view the images shown on viewing side 22a by looking directly at first viewing side 22a. That is, images displayed on viewing side 22a are displayed so as to be viewable when looking directly at viewing side 22a. In such an embodiment, the vehicle operator may view back portion 12b and/or area 30 without looking into rearview mirror 17.

Now, referring to FIG. 2, a block diagram of the display system is provided in accordance with an embodiment of the present invention. The processing of inputs from media device 26 camera 28 and a transmission 35 occurs via a controller 34. Controller 34 may be a digital signal processor (DSP) type device that is adapted to process digitized inputs including data inputs, audio inputs, video inputs, voice inputs, and the like. Such a processor includes the Blackfin® processor that is available from Analog Devices, One Technology Way, P.O. Box 9106, Norwood, Mass. 02062.

As described above, controller 34 is adapted to process signals from media device 26, transmission 35 and camera 28. These processed signals are then transmitted to display 22. It is recognized that in some cases the orientation of images captured by camera 28 may not be suitable for display. For example, the digitized image captured by camera 28 may be misoriented by 180 degrees (or reversed like a mirror image). In such a case, camera 28 may be programmed to automatically output the digitized images with an orientation of, for example, -180 degrees from the originally captured images. Accordingly, the orientation of the image as received by controller 34 will be suitable for display by display 22.

Alternatively, controller 34 may be configured to receive a misoriented image and process the signals so as to provide display 22 the image in the correct orientation. Specifically, controller 34 may be configured to demodulate the digitized signals received by camera 28 and read the data signal starting with the last bit first followed by the next previous bit up until the first received bit is read last. Such processing is analogous to a first-in, last-out processing flow.

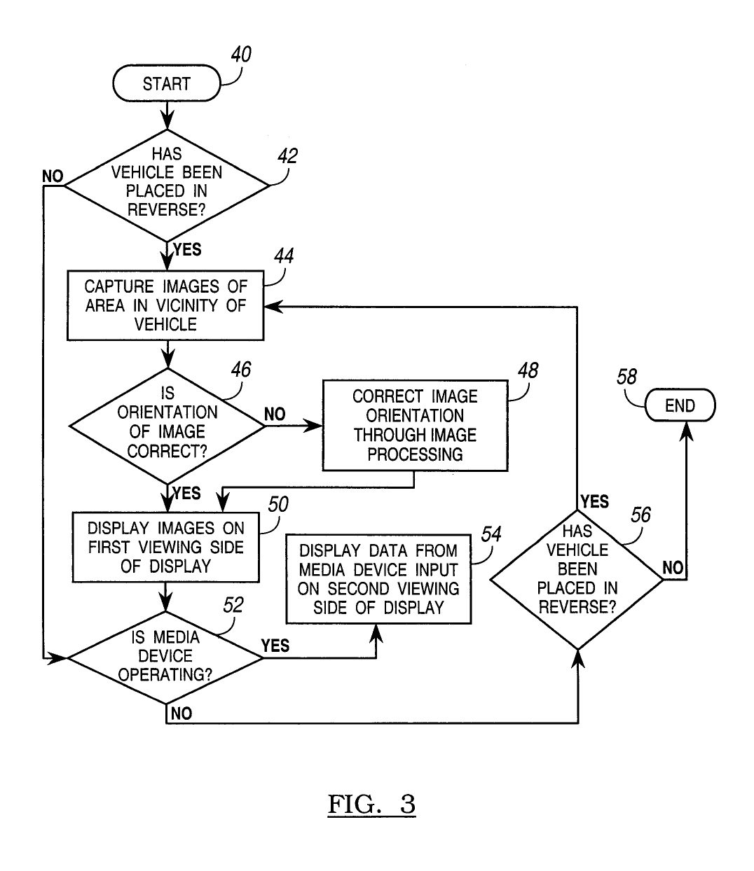

Referring to FIG. 3, a flow chart illustrates a method of processing inputs to be displayed by display 22. A block 40 is the entry point into the method. Block 42 depicts a determination of whether the vehicle has been placed in reverse. As described in the foregoing, the transmission is configured to generate signals for the display system controller that enables the controller to determine whether the driver has placed the vehicle in reverse. As such, if the controller determines that the vehicle has been placed in reverse, the camera 28 is configured to capture images of an area (e.g., area 30 in FIG. 1) in a vicinity of the vehicle, as depicted by block 44. As shown in block 46, the controller determines whether the orientation of the received images is correct (i.e., suitable for display by display 22). If the images are not in the correct orientation, the processor corrects the image orientation through image processing as depicted by block 48. If the orientation of the image is correct at block 46, a block 50 occurs. Additionally, once the orientation is corrected at block 48, block 50 occurs.

As depicted by block 50, the received images from the camera are displayed on the first viewing side 22a (FIG. 1). Following block 50, a block 52 occurs wherein the controller determines whether the media device is operating based on a data input from the media device. Referring back to block 42, if the vehicle has not been placed in reverse, a block 52 also occurs. If the media device is operating (e.g., playing a DVD), the data input from media device is displayed on the second viewing side 26 (FIG. 1) of the display, as depicted by block 54. If the media device is not operating, a block 56 occurs. At block 56, via the controller, the method determines whether the vehicle remains in reverse. If the vehicle is in reverse, the method returns to block 44 where additional images are captured by the camera. If the vehicle is not in reverse, the method ends at block 58.

While the best mode for carrying out the invention has been described in detail, those familiar with the art to which this invention relates will recognize various alternative designs and embodiments for practicing the invention as defined by the following claims.

What is claimed:

1. A display system for a vehicle having an interior with a front portion, the system comprising:
a camera configured to capture images of an area in a vicinity of the vehicle; and
a display unit being in communication with the camera and having a first viewing side for displaying images captured by the camera, wherein the first viewing side faces the front portion of the interior.

2. The system of claim 1, wherein the display unit is configured to receive a first data input and a second data input, wherein the first data input includes data corresponding to the images captured by the camera.

3. The system of claim 2, wherein the interior has a rear portion and wherein the display unit includes a second viewing side that is viewable from the back portion of the interior.

4. The system of claim 3, wherein the second viewing side is configured to display data from the second data input.

5. The system of claim 4, wherein the data from the second data input is generated by a media device.

6. The system of claim 5, wherein the media device includes a vehicle entertainment system.

7. The system of claim 1, wherein the interior includes a roof area and wherein the display unit is mounted to the roof area of the vehicle.

8. The system of claim 1, further comprising a rearview mirror by which the first viewing side is viewable from a front seat of the vehicle.

9. The system of claim 1, wherein the camera is configured to capture still images and/or video of the area.

10. A method of displaying images through the use of a display system within a vehicle having an interior with a front portion, wherein the display system includes a camera and a display unit, the method comprising:
configuring the display unit to have a first viewing side;
capturing images of an area in a vicinity of the vehicle via the camera; and
displaying the images captured by the camera on the first viewing side, wherein the first viewing side faces the front portion of the interior.

11. The method of claim 10, further comprising configuring the display unit to receive a first data input and a second data input, wherein the first data input includes data corresponding to the images captured by the camera, which are displayed on the first viewing side.

12. The method of claim 11, wherein the interior has a back portion and wherein the display unit includes a second viewing side that is viewable from the back portion of the interior.

13. The method of claim 12, further comprising configuring the second viewing side to display data from the second data input.

14. The method of claim 13, wherein the data from the second data input includes a data input that is generated by a media device.

15. The method of claim 14, wherein the media device includes a vehicle entertainment system.

16. The method of claim 10, further comprising mounting the display unit to a roof portion of the interior.

17. The method of claim 10, further comprising a rearview mirror by which the first viewing side is viewable from a front seat of the vehicle.

18. The method of claim 10, wherein the camera is configured to capture still images and/or video of the area.

19. A display system for a vehicle having a rear portion and an interior with a front portion and a back portion, the system comprising:
a camera mounted to the vehicle in the rear portion and being configured to capture images of an area in a vicinity of the rear portion and provide a first data input corresponding to the captured images;
a media device adapted to provide a second data input that correspond to data processed by the media device; and
a display unit being in communication with the camera and the media device, the display unit having a first viewing side that faces the front portion of the interior and a second viewing side that faces the back portion, wherein the first viewing side displays data from the first data input corresponding to the images captured by the camera and the second viewing side displays data from the second data input.

20. The system of claim 19, further comprising a rearview mirror mounted in the front portion of the interior by which the first viewing side is viewable from a front seat of the vehicle.
